(19) United States
(12) Patent Application Publication
(10) Pub. No.: US 2022/0053400 A1
(43) Pub. Date: Feb. 17, 2022

(54) METHODS FOR UPLINK-BASED MOBILITY MANAGEMENT, RELATED NETWORK NODE AND RELATED WIRELESS DEVICE

(71) Applicant: Sony Corporation, Tokyo (JP)

(72) Inventors: Rickard LJUNG, Helsingborg (SE); Peter C KARLSSON, Lund (SE)

(21) Appl. No.: 17/276,758

(22) PCT Filed: Oct. 4, 2019
(86) PCT No.: PCT/SE2019/050969

§ 371 Date: Mar. 16, 2021

(30) Foreign Application Priority Data
Oct. 26, 2018 (SE) 1851331-7

(51) Int. Cl. H04W 36/32; H04W 36/00

(52) U.S. Cl. CPC H04W 36/32; H04W 36/0061; H04W 36/00835; H04W 36/0058

(57) ABSTRACT

A method, performed at a first network node, for up-link-based mobility management is disclose. The method comprises generating one or more configuration messages including generating a first configuration message for configuration of uplink-based mobility, the first configuration message comprising one or more first configuration parameters indicative of an uplink-based mobility scheme for a wireless device; and transmitting the first configuration message to the wireless device.

The present disclosure pertains to the field of wireless communications. More specifically the present disclosure relates to a method, performed at a first network node, for uplink-based mobility management, and a related network node, as well as a method, performed at a wireless device, for uplink-based mobility management and a related wireless device.

### BACKGROUND

In 3^{rd} generation partnership project (3GPP) Release 16, there is an ongoing study on user equipment (UE) power saving for the radio access technology called new radio (NR). One of the fundamental technologies being discussed is the topic of radio resource management (RRM) and in particular the mobility management functions. Within RRM and specifically the mobility management in a wireless communications system using NR, different radio links are being evaluated between UEs and network nodes and decisions are taken to perform radio link measurements and/or to perform handovers or similar to maintain the best possible radio links.

### SUMMARY

Accordingly, there is a need for network nodes, wireless devices and related methods for power efficient radio resource management in wireless communications networks.

A method for uplink-based mobility management is disclosed. The method, performed at a first network node, comprises generating one or more configuration messages including generating a first configuration message for configuration of uplink-based mobility, the first configuration message comprising one or more first configuration parameters indicative of an uplink-based mobility scheme for a wireless device; and transmitting a configuration message, e.g. the first configuration message, to the wireless device.

Further, a network node, e.g. first network node, is provided, the network node comprising a memory module, a processor module, and a wireless interface, wherein the network node is configured to perform a method disclosed herein.

It is an advantage of the present disclosure that a network node is allowed or able to control the usage of uplink-based mobility among wireless devices connected to the network. Thereby, a network node is able to switch to uplink-based mobility when network conditions indicate that uplink-based mobility management is more favorable than downlink-based mobility management.

Further, a method, performed at a wireless device, for uplink-based mobility management is disclosed. The method comprises receiving, from a network node, one or more configuration messages indicative of an uplink-based mobility scheme; and applying an uplink-based mobility scheme in the wireless device according to the one or more configuration messages.

The present disclosure relates to a wireless device comprising a memory module, a processor module, and a wireless interface, wherein the wireless device is configured to perform a method disclosed herein.

It is an advantage of the present disclosure that selective switching between uplink and downlink-based mobility schemes may be performed at the wireless device based on configuration message(s) or signal(s) from the network node. This may result in an increased battery life for the wireless device. A further advantage is the provision of the ability to selectively activate or deactivate an uplink-based mobility scheme independently of the usage of any downlink-based mobility scheme, thereby reducing the control signaling load in the network when uplink-based mobility scheme is not required.

Further, the disclosed methods, network node, and device may be beneficial in certain network deployments, e.g. in heterogeneous networks where macro cells are being used in combination with small cell deployments such as micro cells (because when using downlink-based mobility schemes/procedures, the usage of small cells may impact the number of cells to measure on and report, which in turn may constitute a significant execution complexity in the UE). The UL-based mobility is also beneficial from a UE power consumption point of view since RX duty cycle can be significantly reduced, i.e. avoid measurement of the signal quality from all detected cells (since the mentioned duty cycle may be increasing proportionally to number of cells).

### BRIEF DESCRIPTION OF THE DRAWINGS

The above and other features and advantages of the present disclosure will become readily apparent to those skilled in the art by the following detailed description of exemplary embodiments thereof with reference to the attached drawings, in which:

FIG. 1 is a diagram illustrating an exemplary wireless communication system comprising an exemplary network node and an exemplary wireless device according to this disclosure,

FIG. 2 is a flow diagram of an exemplary method, performed at a first network node according to the disclosure,

FIG. 3 is a flow diagram of an exemplary method, performed at a wireless device according to the disclosure,

FIG. 4 schematically illustrates an exemplary network node according to the disclosure,

FIG. 5 schematically illustrates an exemplary wireless device according to the disclosure,

FIG. 6 illustrates an exemplary signaling diagram between an exemplary first network node and an exemplary wireless device, and

FIG. 7 illustrates an exemplary signaling diagram between an exemplary first network node and an exemplary wireless device according to this disclosure.

### DETAILED DESCRIPTION

Various exemplary embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

The present disclosure relates to radio resource management and mobility management, e.g. in order to handle, manage and/or perform cell measurements and evaluations for e.g. initiating handover procedures. Radio resource management and mobility management are performed using mobility schemes (e.g. downlink-based mobility schemes and/or uplink-based mobility schemes) based on measurements of radio links between wireless devices (UEs) and base stations/cells. One such method of link evaluations can be based on wireless devices or UEs performing measurements on signals transmitted by the base station, denoted as downlink, DL, based measurements. Downlink-based measurement are performed by the UE measuring the downlink signals (e.g. pilots and/or reference signals) transmitted by network nodes and may perform reporting of the measurements, detected cells and optionally their quality to the network node.

Radio resource management and mobility management may be improved by uplink-based mobility measurements. It is envisioned to introduce a functionality at a network node where the network node is capable of measuring the radio link quality based on uplink signal(s) transmitted by a UE. This principle differs from the legacy methodology of radio link evaluations for RRM based on DL measurement. Uplink-based mobility measurements may be advantageous in measuring radio link conditions in an uplink channel, e.g. particularly in network deployments, e.g. in heterogeneous networks where macro cells are used in combination with small cell deployments such as micro cells because the number of detected cells may become large and the UE complexity to measure on a large number of cells could become unreasonably large. In case an uplink-based measurement is performed for mobility management the UE may transmit a signal which one or more network nodes may detect. Based on for example communicating the properties of the detected uplink signal in-between network nodes, the serving cell may be notified that one or more neighbor cells may be suitable for communication with the UE. The network may use this information as part of its mobility management procedures.

The network node is capable of determining a need for a handover based on the uplink-based mobility measurements/schemes enabled according to this disclosure.

In certain implementations this method may result in lower latency for cell evaluations compared to downlink-based measurements. Further in certain implementations this method may result in more accurate cell evaluations. Further, certain implementations may combine uplink and downlink-based measurements, if configured by the network.

The present disclosure elaborates on the RRM procedures and the signaling related to configurations of UE for the transmission of the uplink signal required to perform uplink-based mobility and uplink-based mobility. The present disclosure proposes a configuration control technique with one or more signaling messages which configure use of uplink-based mobility, and also controls the uplink reference signal transmitted by the UE to be used for the measurements.

The present disclosure proposes to optimize the radio resource management (RRM) in the network node by generating one or more configuration signals for configuration of an uplink-based mobility procedure/scheme. This may allow a selective inclusion of relevant configuration parameters in the configuration signal(s), e.g. configuration parameters indicative of trigger parameters or events to be used for applying uplink-based mobility scheme and/or downlink-based mobility scheme, for example switching between a downlink-based mobility scheme and an uplink-based mobility scheme and/or vice versa. It should be understood that although the present disclosure describes the configuration to be performed via multiple configuration messages, these configuration messages may be implemented as one or multiple information elements or configuration parameters contained within one single configuration message. Hence, it is to be understood that the network configuration to a wireless device of usage of uplink-based measurement procedure may be performed by a single transmission of a single configuration message that includes one or more information elements.

As discussed in detail herein, the present disclosure relates to a wireless communications system, also denoted wireless communications network, comprising a cellular system, e.g. a 3GPP wireless communication system. The network node refers to a wireless node operating in the wireless communications network, e.g. the network node may be a radio access node, such as a base station, an evolved Node B, eNB, a gNB. The wireless communications system described herein may comprise one or more wireless devices and one or more network nodes, such as one or more of: a base station, an eNB, a gNB and/or an access point. A wireless device may be referred to as a mobile device and/or a user equipment, UE.

The figures are schematic and simplified for clarity, and they merely show details which are essential to the understanding of the disclosure, while other details have been left out. Throughout, the same reference numerals are used for identical or corresponding parts.

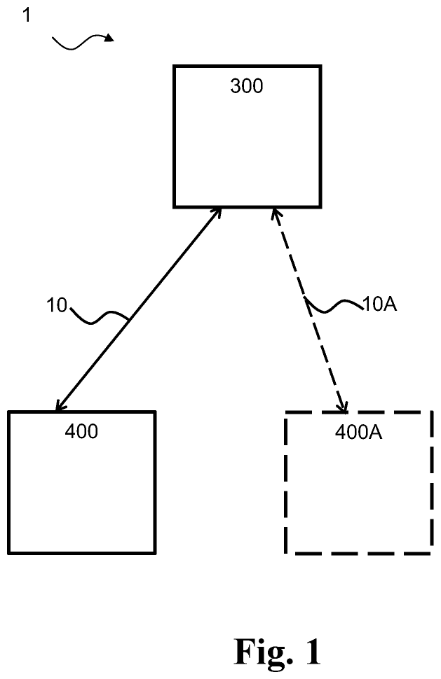

FIG. 1 is a diagram illustrating an exemplary wireless communication system 1 comprising an exemplary network node 300 and an exemplary wireless device 400 according to this disclosure. As discussed in detail herein, the present disclosure relates to a wireless communication system 1 comprising a cellular system, e.g. a 3GPP wireless communication system. The wireless communication system 1 comprises a wireless device 400 and/or a network node 300. A network node disclosed herein refers to a radio access network node operating in the radio access network, such as a base station, an evolved Node B, eNB, a gNB (e.g. a Node B for 5G NR). The wireless communication system 1 described herein may comprise one or more wireless devices 400, 400A, and/or one or more network nodes 300, such as one or more of: a base station, an eNB, a gNB and/or an access point.

A wireless device 400 may refer to as a mobile device and/or a user equipment, UE. Examples of wireless device include a tablet, a mobile phone, and/or a portable electronic device. The wireless device 400, 400A may be configured to communication with the network node 300 via a wireless link (or radio access link) 10, 10A.

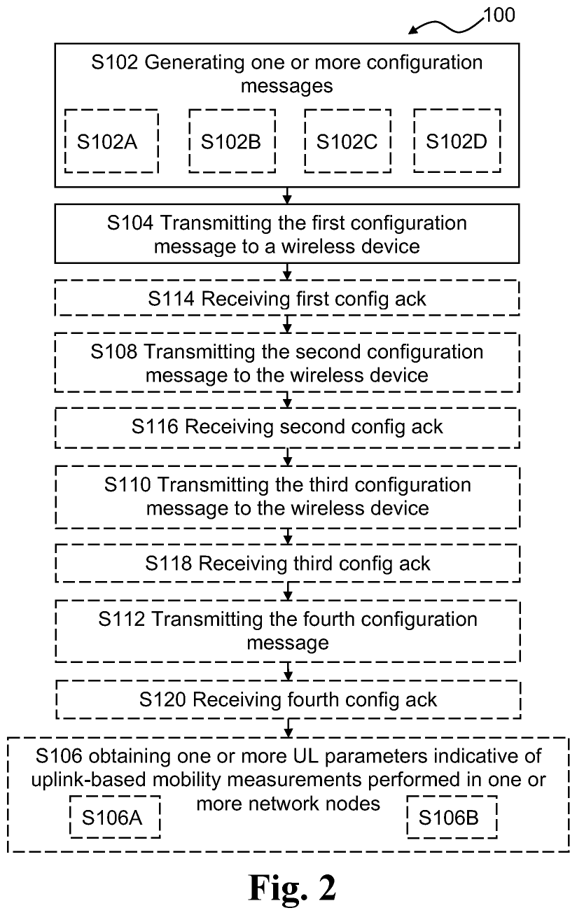

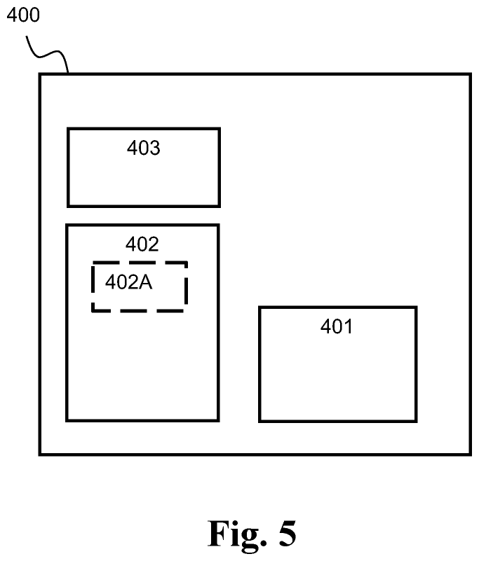

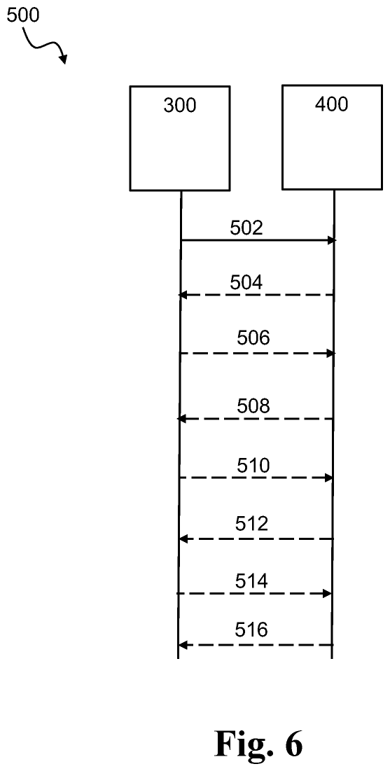

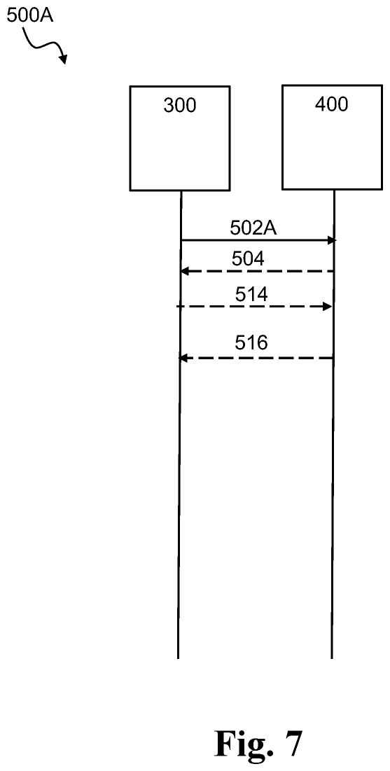

FIG. 2 is a flow diagram of an exemplary method 100 according to the disclosure. The method 100 is performed at a first network node (e.g. exemplary network node 300 of any of FIG. 1, FIG. 5, FIGS. 6-7) for uplink-based mobility management, e.g. in a wireless communications network. The method 100 comprises generating S102 one or more configuration messages. Generating S102 one or more configuration messages may comprise generating S102A a first configuration message for configuration of uplink-based mobility. The first configuration message may be denoted “UL/DL-based measurement event configuration message”. The first configuration message comprises one or more first configuration parameters indicative of an uplink-based mobility scheme for a wireless device, e.g. wireless device 400 of FIG. 1 and FIG. 5.

The method 100 comprises transmitting one or more configuration messages including transmitting S104 the first configuration message to the wireless device. It is to be understood that although the present disclosure and FIG. 2 and FIG. 6 details multiple configuration messages, in practice the transmission of one or more configuration messages to a wireless device (UE) can be performed within one transmission of one single configuration message. The single configuration message may consist of multiple transmitted bits that together comprises information that is indicative of the one or more configuration messages and configuration parameters described herein. Hence, the sequential illustration in FIG. 2 and FIG. 6 is not necessarily to be interpreted as and limited to a sequential transmission in time domain. Instead the generation of the configuration message may comprise combining one or more configuration parameters, such as combining first configuration parameters with second and/or third configuration parameters into a single configuration message/signal transmission.

The first configuration parameter(s) indicative of an uplink-based mobility scheme for a wireless device may be denoted first uplink configuration parameters. In one or more exemplary methods, the one or more first (uplink) configuration parameters are indicative of a request to apply uplink-based mobility scheme in the wireless device. In other words, the first configuration message may be seen as a request message instructing or requesting a wireless device to apply uplink-based mobility scheme in response to receiving the first configuration message.

In one or more exemplary methods, the one or more first configuration parameters comprise an uplink criteria configuration indicative of uplink criteria to be satisfied for a wireless device to apply an uplink-based mobility scheme. In other words, the one or more first (uplink) configuration parameters may define or select an uplink criteria configuration indicative of uplink criteria to be satisfied for a wireless device to apply an uplink-based mobility scheme. The uplink criteria configuration may include and/or define triggers or events for the usage of or switching to or applying uplink-based mobility scheme in UEs. In other words, the uplink criteria configuration may define uplink criteria to be satisfied for a wireless device to apply or switch to an uplink-based mobility scheme.

In one or more exemplary methods, the uplink criteria configuration comprises one or more uplink thresholds used in the uplink criteria to be satisfied.

In one or more exemplary methods, the uplink criteria configuration, e.g. the one or more uplink thresholds, comprises one or more of a first neighbour cell threshold, TH_NC_UL_1, indicative of a threshold for number of detected neighbour cells, a second neighbour cell threshold, TH_NC_UL_2, indicative of a threshold for an average number of detected neighbour cells over a given time period, a first primary cell threshold, TH_PC_UL_2, indicative of a threshold for signal strength of primary cell, a second primary cell threshold, TH_PC_UL_2, indicative of a threshold for signal quality of primary cell, and a third primary cell threshold, TH_PC_UL_2, indicative of a threshold for number of primary cell changes performed in a time period. Other threshold parameters may be included, e.g. the required signal strength or quality of a neighbour cell in order to count it as a detected neighbour cell.

The first configuration message may comprise one or more first configuration parameters indicative of a downlink-based mobility scheme for a wireless device. First configuration parameter(s) indicative of a downlink-based mobility scheme for a wireless device may be denoted first downlink configuration parameters.

In one or more exemplary methods, the one or more first configuration parameters comprise a downlink criteria configuration indicative of downlink criteria to be satisfied for a wireless device to stop applying the uplink-based mobility scheme and/or to start applying a downlink based mobility scheme in the wireless device. A configuration parameter relating to stop applying the UL based mobility scheme is indicative of a scheme for UL based mobility since it involves stopping the UL based mobility scheme.

In one or more exemplary methods, the downlink criteria configuration comprises one or more downlink thresholds used in the downlink criteria to be satisfied.

In one or more exemplary methods, the downlink criteria configuration comprises one or more of a first neighbour cell threshold, TH_NC_DL_1, indicative of a threshold for number of detected neighbour cells, a second neighbour cell threshold, TH_NC_DL_2, indicative of a threshold for an average number of detected neighbour cells over a given time period, a first primary cell threshold, TH_PC_DL_1, indicative of a threshold for signal strength of primary cell, a second primary cell threshold, TH_PC_DL_2, indicative of a threshold for signal quality of primary cell, and a third primary cell threshold, TH_PC_DL_3, indicative of a threshold for number of primary cell changes performed in a time period.

In one or more exemplary methods, uplink criteria and/or downlink criteria may comprise or be based on packet error rate statistics or similar.

In one or more exemplary methods, the uplink criteria to be satisfied are different from the downlink criteria to be satisfied. For example, the uplink criteria and the downlink criteria may be based on different uplink thresholds and downlink thresholds, e.g. different neighbour cell thresholds and/or different threshold values of a respective neighbour cell threshold.

In one or more exemplary methods, TH_NC_UL_1 is different from TH_NC_DL_1, e.g. TH_NC_UL_1>TH_NC_DL_1. In one or more exemplary methods, TH_NC_UL_2 is different from TH_NC_DL_2, e.g. TH_NC_UL_2>TH_NC_DL_2. In one or more exemplary methods, TH_PC_UL_1 is different from TH_PC_DL_1. In one or more exemplary methods, TH_PC_UL_2 is different from TH_PC_DL_2. In one or more exemplary methods, TH_PC_UL 3 is different from TH_PC_DL_3. Different thresholds and/or criteria enable a hysteresis to be configured in order not to result in ping-pong effects of rapid changes (e.g. thereby avoided or reduced) between UL and DL based measurements for a given UE and in a given cell structure.

The method 100 optionally comprises obtaining S106 one or more UL parameters indicative of uplink-based mobility measurements performed in one or more network nodes. Obtaining S106 one or more UL parameters optionally comprises performing S106A uplink-based mobility measurements for provision of one or more UL parameters indicative of uplink-based mobility measurements in accordance with the one or more configuration messages. Obtaining S106 one or more UL parameters optionally comprises receiving S106B one or more UL parameters indicative of uplink-based mobility measurements from a second network node.

In one or more exemplary methods, generating S102 one or more configuration messages comprises generating S102B a second configuration message. The second configuration message may be denoted “UL-based measurement signal design message”. The second configuration message comprises one or more second configuration parameters indicative of a reference signal configuration. The method optionally comprises transmitting S108 the second configuration message to the wireless device.

In one or more exemplary methods, the one or more second configuration parameters indicative of a reference signal configuration may be included in the first configuration message, such as in a single first configuration message. In other words, the first configuration message may comprise one or more second configuration parameters indicative of a reference signal configuration, such as for a reference signal to be transmitted from the wireless device. In other words, the reference signal configuration may define or indicate a configuration of an uplink reference signal, such as uplink reference signal transmitted be the UE, e.g. for measurements. Stated differently, one or more of the second configuration parameters may act as or constitute the first configuration parameter(s) in that the second configuration parameters are indicative of an uplink-based mobility scheme for a wireless device.

In one or more exemplary methods, the one or more second configuration parameters are indicative of a Non-Orthogonal Multiple Access, NOMA, configuration. This is advantageous in allowing multiple UEs to transmit on the same resources at the same time. Thus, NOMA can be used for several wireless devices to transmit simultaneously in the uplink, i.e. without dedicated resource, slot or a grant from the network node.

Thus, the configuration signals can be used to configure specifically how the UEs shall construct the NOMA reference signal based on second configuration parameter(s). In one or more exemplary methods, performing S106A uplink-based mobility measurements in at the first network node is performed in accordance with the one or more second configuration parameters.

In one or more exemplary methods, generating S102 one or more configuration messages comprises generating S102C a third configuration message. The third configuration message may be denoted “UL-based measurement resource allocation message”. The The third configuration message comprises one or more third configuration parameters indicative of physical resources to be used by the wireless device for transmitting reference signals. The method optionally comprises transmitting S110 the third configuration message to the wireless device. Performing S106A uplink-based mobility measurements is optionally performed in accordance with the one or more third configuration parameters.

In one or more exemplary methods, the one or more third configuration parameters indicative of physical resources to be used by the wireless device for transmitting reference signals may be included in the first configuration message, such as in a single first configuration message, and/or in the second configuration message. In other words, the first configuration message and/or the second configuration message may comprise one or more third configuration parameters indicative of physical resources to be used by the wireless device for transmitting reference signals. Stated differently, one or more of the third configuration parameters may act as or constitute the first configuration parameter(s) in that the third configuration parameter(s) are indicative of an uplink-based mobility scheme for a wireless device.

The network (via a network node as disclosed herein) may configure, e.g. with configuration parameters of the one or more configuration messages, such as the third configuration parameters, reoccurring time resources for when the wireless device shall transmit uplink pilots (reference signals) for uplink-based measurements, e.g. as part of the third configuration parameters. The reoccurring resources may be dynamically allocated depending on similar type of parameters as the triggers for activation of uplink-based mobility (uplink criteria, uplink thresholds). Hence, the wireless device may transmit uplink pilots (reference signals) more often when e.g. the current signal quality to primary cell is low compared to a case with better signal quality. From a network perspective, it is for example possible that a wireless device is configured with different transmission frequency (for reference signals) depending on the total number of connected wireless devices in the cell. Such dependency on number of connected wireless devices could be a reason for the network to configure or reconfigure the resources.

In one or more exemplary methods, generating S102 one or more configuration messages comprises generating S102D a fourth configuration message indicative of deactivation of uplink-based mobility measurements, the method optionally comprising transmitting S112 the fourth configuration message to the wireless device. Thereby, the (first) network node is able to control both activation and deactivation of uplink-based mobility scheme in the wireless device. The fourth configuration message may be a wireless device specific (e.g. an RRM signal) or a broadcasted signal in case the network node deactivates uplink-based measurements for all wireless devices in the cell (or multiple surrounding/adjacent cells). In one or more exemplary methods, when the fourth configuration message is sent, only the legacy DL-based measurements for mobility measurements is used until another triggering event (e.g. indicated by first configuration message) and/or UL criteria met.

The method may comprise one or more of receiving 114 a first configuration acknowledgement from the wireless device, receiving 116 a second configuration acknowledgement from the wireless device, receiving 118 a third configuration acknowledgement from the wireless device, and receiving 120 a fourth configuration acknowledgement from the wireless device. The first configuration acknowledgement acknowledges receipt of the first configuration message in the wireless device. The second configuration acknowledgement acknowledges receipt of the second configuration message in the wireless device. The third configuration acknowledgement acknowledges receipt of the third configuration message in the wireless device. The fourth configuration acknowledgement acknowledges receipt of the fourth configuration message in the wireless device. It should be understood that although the present disclosure describes multiple acknowledgements, this could be implemented as transmitting a single acknowledgement where the acknowledgement refers to acknowledge to the configuration information that has been received. Hence, similarly to the transmission of the configuration from the network node which may in one single transmission consist of one or multiple configuration information elements the acknowledgement can also refer to one or multiple acknowledgements transmitted as one single transmission. In other words, one exemplary implementation of the method includes transmitting one configuration signal and one acknowledgement signal, although technically referring to what is here denoted as multiple messages and multiple acknowledgements.

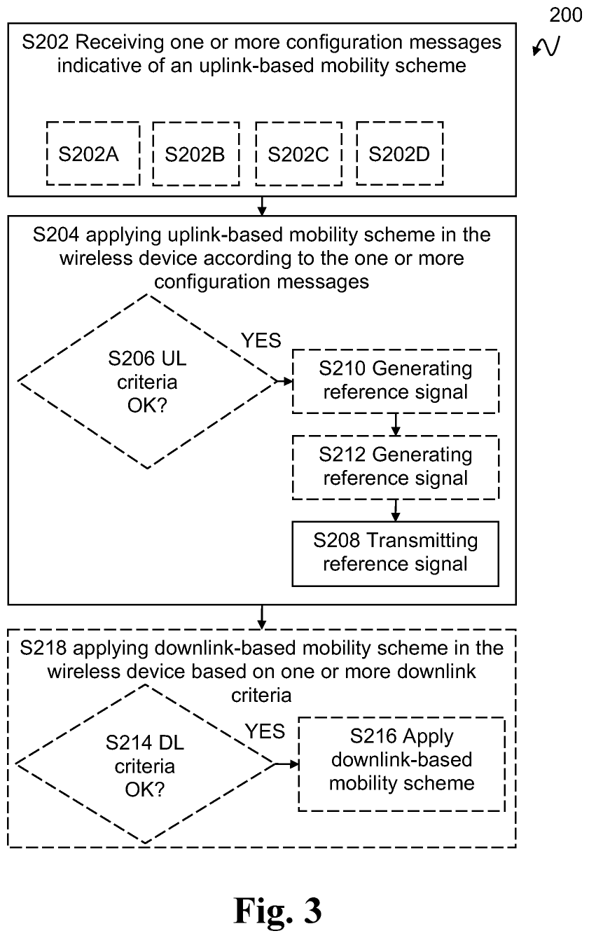

FIG. 3 shows a flow diagram illustrating an exemplary method 200 performed at a wireless device (e.g. exemplary wireless device 400 of any of FIGS. 1, 5, 6, 7) according to this disclosure. The method 200 is performed for uplink-based mobility management, e.g. in a wireless communications network (illustrated in FIG. 1).

The method 200 comprises receiving S202, from a network node, e.g. from network node 300, one or more configuration messages indicative of an uplink-based mobility scheme; and applying S204 an uplink-based mobility scheme in the wireless device according to the one or more configuration messages.

In one or more exemplary methods, receiving S202, from a network node, one or more configuration messages indicative of an uplink-based mobility scheme comprises receiving 5202A a first configuration message. The first configuration message optionally comprises one or more first configuration parameters. The one or more first configuration parameters may be indicative of an uplink-based mobility scheme for a wireless device. For example, the one or more first configuration parameters may comprise an uplink criteria configuration indicative of uplink criteria to be satisfied for the wireless device to apply an uplink-based mobility scheme, and wherein applying S204 uplink-based mobility scheme in the wireless device according to the one or more configuration messages optionally comprises determining S206 if uplink criteria are satisfied; and in accordance with uplink criteria being satisfied, transmitting S208 a reference signal to one or more network nodes. In other words, the method may comprise switching to an uplink-based mobility scheme, e.g. from a downlink-based mobility scheme in accordance with uplink criteria being satisfied.

In one or more exemplary methods, an uplink criteria configuration, e.g. as defined by first configuration parameters, comprises a first neighbour cell threshold, TH_NC_UL_1, wherein the uplink criteria configuration defines that uplink criteria are satisfied if a number N_NC of detected neighbour cells (detected by the wireless device) is larger than the first neighbour cell threshold, TH_NC_UL_1. Thus, the uplink criteria may be satisfied (or partly satisfied) if N_NC>TH_NC_UL_1. In one or more exemplary methods, the first neighbour cell threshold, TH_NC_UL_1, of the uplink thresholds is in the range from 5 to 30, e.g. 10, 15, 20, 25 or any ranges therebetween. Thus, the wireless device may apply uplink-based mobility scheme if the number N_NC of detected neighbour cells is too high.

In one or more exemplary methods, an uplink criteria configuration, e.g. as defined by first configuration parameters, comprises a first primary cell threshold, TH_PC_UL_1, indicative of a threshold for signal strength of primary cell and/or a second primary cell threshold, TH_PC_UL_2 indicative of a threshold for signal quality of primary cell, and wherein the uplink criteria configuration comprises TH_PC_UL_1 and/or

TH_PC_UL_2. For example, the uplink criteria configuration may define that uplink criteria are satisfied if a detected signal strength of primary cell, SS_PC, is less than the first primary cell threshold, TH_PC_UL_1. Thus, the uplink criteria may be satisfied (or partly satisfied) if SS_PC<TH_PC_UL_1. For example, the uplink criteria configuration may define that uplink criteria are satisfied if a detected signal quality of primary cell, SQ_PC, is less than the second primary cell threshold, TH_PC_UL_2. Thus, the uplink criteria may be satisfied (or partly satisfied) if SQ_PC<TH_PC_UL_2.

It is to be noted that a plurality of thresholds and criteria dependent thereon may be combined in the uplink criteria configuration (transmitted by the network node and/or used by the wireless device). The values of uplink thresholds may be specified by the network node and adapted to the specific network configuration of the communications network.

In one or more, the uplink criteria may be satisfied (or partly satisfied) if N_NC>TH_NC_UL_1 AND SS_PC<TH_PC_UL_1. In one or more, the uplink criteria may be satisfied (or partly satisfied) if N_NC>TH_NC_UL_1 AND SQ_PC<TH_PC_UL_2.

In one or more exemplary methods, receiving S202, from the network node, one or more configuration messages comprises receiving S202B a second configuration message, the second configuration message comprising one or more second configuration parameters indicative of a reference signal configuration, and applying S204 uplink-based mobility scheme in the wireless device according to the one or more configuration messages optionally comprises generating S210 a reference signal based on at least one of the one or more second configuration parameters, and transmitting S208 the reference signal to one or more network nodes. Stated differently, a network node transmits a reference signal configuration to the wireless signal in the second configuration message (or in the first configuration message), and the wireless device applying uplink-based mobility scheme generates and transmits the reference signal used for uplink-based mobility measurements in network nodes based on the reference signal configuration.

In one or more exemplary methods, the one or more second configuration parameters are indicative of a Non-Orthogonal Multiple Access, NOMA, configuration, and the reference signal is based on the Non-Orthogonal Multiple Access configuration. In other words, the reference signal configuration may include a NOMA configuration to be used by the wireless device for generating and transmitting the reference signal used for uplink-based mobility measurements in network nodes based on the reference signal configuration. Accordingly, the uplink pilot signals to be used for uplink-based mobility measurements may use the NOMA functionality, where multiple UEs can transmit on the same resources at the same time. Accordingly, the presently disclosed signaling protocol as optionally defined by the second configuration parameters can be used to configure specifically how the wireless device shall construct the (NOMA) reference signal based on network preferences. NOMA uses a type of code division multiplexing and typically the NOMA schemes may differ in the reference signal design by applying different codes (different code types and/or code lengths) to the reference signal in order to achieve different code multiplexing gains depending on the network node receiver architectures.

In one or more exemplary methods, the one or more second configuration parameters are indicative of one or both of an antenna configuration and a transmission power level configuration, and wherein the reference signal is based on the antenna configuration and/or the transmission power level configuration. One or more exemplary reference signal configurations may include and/or define usage of multiple antennas, switching between different antennas or other antenna configurations. One or more exemplary reference signal configurations may include and/or define transmission power level selection. Thus, other wireless device specific pilot signal design configurations (second configuration parameters) besides a NOMA scheme setting could include or be indicative of usage of multiple antennas, switching between different antennas or other antenna configurations and transmission power level selection.

In one or more exemplary methods, receiving S202, from the network node, one or more configuration messages comprises receiving S202C a third configuration message, the third configuration message comprising one or more third configuration parameters indicative of physical resources to be used by the wireless device for transmitting reference signals, and wherein applying S204 uplink-based mobility scheme in the wireless device according to the one or more configuration messages comprises generating S212 a reference signal based on at least one of the one or more third configuration parameters, and transmitting S208 the reference signal to one or more network nodes.

In one or more exemplary methods, receiving S202, from the network node, one or more configuration messages comprises receiving S202D a fourth configuration message indicative of deactivation of uplink-based mobility scheme, and wherein applying S204 uplink-based mobility scheme in the wireless device according to the one or more configuration messages optionally comprises, in response to receiving the fourth configuration message, deactivating the uplink-based mobility scheme. In one or more exemplary methods, deactivating the uplink-based mobility scheme comprises switching to a downlink-based mobility scheme.

The uplink criteria may be included in a first configuration message (first configuration parameters) and/or retrieved from a memory of the wireless device.

In one or more exemplary method, the method comprises determining S214 if a downlink criterion or downlink criteria is/are satisfied; and in accordance with downlink criteria being satisfied, applying S216 a downlink-based mobility scheme in the wireless device. In other words, the method may comprise S218 applying downlink-based mobility scheme in the wireless device based on one or more downlink criteria. The downlink criterion may be defined by a downlink criteria configuration, e.g. stored in the memory of the wireless device and/or received from a network node, e.g. as part a first configuration message (first (downlink) configuration parameters).

In one or more exemplary methods, a downlink criteria configuration, e.g. as defined by the first configuration parameters, comprises a first neighbour cell threshold, TH_NC_DL_1, wherein the downlink criteria configuration defines that the downlink criterion is satisfied if a number N_NC of detected neighbour cells (detected by the wireless device) is less than the first neighbour cell threshold, TH_NC_DL_1. Thus, the downlink criterion may be satisfied if N_NC<TH_NC_DL_1. In one or more exemplary methods, the first neighbour cell threshold, TH_NC_DL_1, of the downlink thresholds is in the range from 5 to 20, e.g. 10, 15, 20, 25 or any ranges therebetween. In one or more exemplary methods, the first neighbour cell threshold, TH_NC_DL_1, of the downlink thresholds is less than the first neighbour cell threshold, TH_NC_UL_1, of the uplink thresholds. Thus, the wireless device may apply downlink-based mobility scheme if the number N_NC of detected neighbour cells is sufficiently low.

It is to be noted that a plurality of thresholds and criteria dependent thereon may be combined in the downlink criteria configuration (transmitted by the network node and/or used by the wireless device). The values of downlink thresholds may be specified by the network node and adapted to the specific network configuration of the communications network. The downlink criterion/downlink criteria configuration may be included in the first configuration message (first configuration parameters) and/or retrieved from a memory of the wireless device

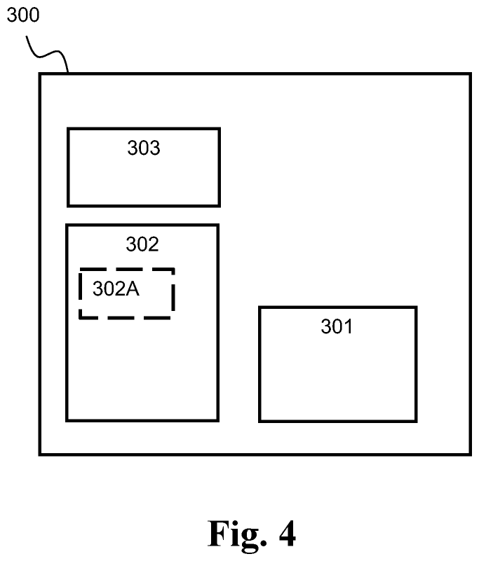

FIG. 4 is a block diagram illustrating an exemplary network node 300 according to this disclosure. The present disclosure relates to a network node 300 of a wireless communication network. Examples of a network node include a base station, an evolved NodeB, and/or an access point.

The network node 300 comprises a memory module 301, a processor module 302, and a wireless interface 303. The network node 300 is configured to perform any of the methods disclosed herein, such as any of the methods shown in FIG. 2.

The processor module 302 is configured to generate, e.g. using a configuration message generator module 302A, one or more configuration messages to be transmitted for uplink-based mobility management.

The processor module 302 is configured to transmit, e.g. using the wireless interface 303, the one or more configuration messages.

The processor module 302 may be configured to perform any of the steps S102, S102A, S102B, S102C, S102D, S104, S106, S108, S110, S112, S114, S116, S118, and S120 (disclosed in FIG. 2).

The wireless interface 303 is configured for wireless communications via a wireless communications network, such as a 3GPP system, such as a 3GPP system with operations in the unlicensed band, such as a 3GGP system with New Radio and unlicensed band operations. The wireless interface 303 may be configured to transmit the one or more configuration messages to a wireless device (such as a wireless device disclosed herein).

The processor module 302 is optionally configured to perform any of the operations disclosed in FIG. 2. The operations of the (first) network node 300 may be embodied in the form of executable logic routines (e.g., lines of code, software programs, etc.) that are stored on a non-transitory computer readable medium (e.g., the memory module 301) and are executed by the processor module 302).

Furthermore, the operations of the network node 300 may be considered a method that the network node 300 is configured to carry out. Also, while the described functions and operations may be implemented in software, such functionality may as well be carried out via dedicated hardware or firmware, or some combination of hardware, firmware and/or software.

The memory module 301 may be one or more of a buffer, a flash memory, a hard drive, a removable media, a volatile memory, a non-volatile memory, a random access memory (RAM), or other suitable device. In a typical arrangement, the memory module 301 may include a non-volatile memory for long term data storage and a volatile memory that functions as system memory for the processor module 302. The memory module 301 may exchange data with the processor module 302 over a data bus. Control lines and an address bus between the memory module 301 and the processor module 302 also may be present (not shown in FIG. 4). The memory module 301 is considered a non-transitory computer readable medium.

FIG. 5 is a block diagram illustrating an exemplary wireless device 400 according to this disclosure. The wireless device 400 is a wireless electronic device and comprises a memory module 401, a processor module 402, and a wireless interface 403. The wireless electronic device 400 may be configured to perform any of the methods disclosed in FIG. 3.

The wireless device 400 is configured to communicate with a network node, such as the network node disclosed herein, using a wireless communications network.

The wireless device 400 is configured to receive, from a network node via the wireless interface 403, one or more configuration messages indicative of an uplink-based mobility scheme.

The wireless device 400 is configured to applying, via the processor module 402 (e.g. via a mobility module 402A), an uplink-based mobility scheme in the wireless device according to the one or more configuration messages.

The wireless electronic device 400 is configured to performing any of the steps S202, S202A, S202B, S202D, S204, S206, S208, S210, S212 of FIG. 3.

The processor module 402 is optionally configured to perform any of the operations disclosed in FIG. 4. The operations of the wireless electronic device 400 may be embodied in the form of executable logic routines (e.g., lines of code, software programs, etc.) that are stored on a non-transitory computer readable medium (e.g., the memory module 401) and are executed by the processor module 402).

While the described functions and operations may be implemented in software, such functionality may as well be carried out via dedicated hardware or firmware, or some combination of hardware, firmware and/or software.

The memory module 401 may be one or more of a buffer, a flash memory, a hard drive, a removable media, a volatile memory, a non-volatile memory, a random access memory (RAM), or other suitable device. In a typical arrangement, the memory module 401 may include a non-volatile memory for long term data storage and a volatile memory that functions as system memory for the processor module 402. The memory module 401 may exchange data with the processor module 402 over a data bus. Control lines and an address bus between the memory module 401 and the processor module 402 also may be present (not shown in FIG. 5). The memory module 401 is considered a non-transitory computer readable medium.

The memory module 401 may be configured to store an uplink criteria configuration and/or a downlink criteria configuration.

The wireless interface 403 is configured for wireless communications via a wireless communications network, such as a 3GPP system, such as a 3GPP system with operations in the unlicensed band, such as a 3GGP system with New Radio and unlicensed band operations. The wireless interface 403 may be configured to transmit reference signal according to the one or more configuration messages to one or more network nodes (such as a network node disclosed herein).

FIG. 6 illustrates an exemplary signaling diagram 500 between a network node 300 and a wireless device 400. The (first) network node 300 transmits a first configuration message 502 comprising first configuration parameter(s) to the wireless device 400. The first configuration message 502 (first configuration parameter(s), also denoted a UL/DL based measurement event configuration message, may define or set parameters for the uplink criteria and/or the downlink criteria, e.g. for selection and/or switching between UL and DL based measurements. Optionally, the wireless device transmits first configuration acknowledgement 504 to the network node in response to receiving the first configuration message 502.

The (first) network node 300 optionally transmits a second configuration message 506 comprising second configuration parameter(s) to the wireless device 400. The second configuration message or at least the second configuration parameter(s) define the signal design to be used by the UE when transmitting uplink signals (pilot signals/reference signals) for RRM measurements. The second configuration parameters may include a code design/reference signal configuration, e.g. for NOMA transmissions. Optionally, the wireless device transmits second configuration acknowledgement 508 to the network node in response to receiving the second configuration message 506.

The (first) network node 300 optionally transmits a third configuration message 510 comprising third configuration parameter(s) to the wireless device 400. The third configuration message or at least third configuration parameter(s) is indicative of the physical resources to be used by the UE for transmitting uplink signals (pilot signals/reference signals) for RRM measurements. Optionally, the wireless device transmits third configuration acknowledgement 512 to the network node in response to receiving the third configuration message 510.

The (first) network node 300 optionally transmits a fourth configuration message 514 indicative of deactivation of uplink-based mobility scheme to the wireless device 400. Optionally, the wireless device transmits fourth configuration acknowledgement 516 to the network node in response to receiving the fourth configuration message 514.

FIG. 7 illustrates an exemplary signaling diagram 500A between a network node 300 and a wireless device 400. The (first) network node 300 transmits a first configuration message 502A comprising first configuration parameter(s), second configuration parameter(s) and third configuration parameter(s) to the wireless device 400. The first configuration parameter(s) may define or set parameters for the uplink criteria (uplink criteria configuration) and/or the downlink criteria (downlink criteria configuration), e.g. for selection and/or switching between UL and DL based measurements. The second configuration parameter(s) may define the signal design to be used by the UE when transmitting uplink signals (pilot signals/reference signals) for RRM measurements. The second configuration parameters may include a code design/reference signal configuration, e.g. for NOMA transmissions. The third configuration parameter(s) is indicative of the physical resources to be used by the wireless device for transmitting uplink signals (pilot signals/reference signals) for RRM measurements.

Embodiments of methods and products (network node and wireless device) according to the disclosure are set out in the following items:
Item 1. A method (100), performed at a first network node, for uplink-based mobility management, the method comprising:
   generating (S102) one or more configuration messages including generating (S102A) a first configuration message for configuration of uplink-based mobility, the first configuration message comprising one or more first configuration parameters indicative of an uplink-based mobility scheme for a wireless device; and
   transmitting (S104) the first configuration message to the wireless device.
Item 2. Method according to item 1, wherein the one or more first configuration parameters are indicative of a request to apply uplink-based mobility scheme in the wireless device.
Item 3. Method according to any of items 1-2, wherein the one or more first configuration parameters comprise an uplink criteria configuration indicative of uplink criteria to be satisfied for a wireless device to apply an uplink-based mobility scheme.
Item 4. Method according to item 3, wherein the uplink criteria configuration comprises one or more of a first neighbour cell threshold indicative of a threshold for number of detected neighbour cells, a second neighbour cell threshold indicative of a threshold for an average number of neighbour cells detected over a given time period, a first primary cell threshold indicative of a threshold for signal strength of primary cell, a second primary cell threshold indicative of a threshold for signal quality of primary cell, and a third primary cell threshold indicative of a threshold for number of primary cell changes performed in a time period.
Item 5. Method according to any of items 1-4, wherein the one or more first configuration parameters comprise a downlink criteria configuration indicative of downlink criteria to be satisfied for a wireless device to stop applying the uplink-based mobility scheme and to start applying a downlink-based mobility scheme in the wireless device.
Item 6. Method according to item 5 as dependent on any of items 3-4, wherein the uplink criteria to be satisfied are different from the downlink criteria to be satisfied.
Item 7. Method according to any of items 5-6, wherein the downlink criteria configuration comprises one or more of a first neighbour cell threshold indicative of a threshold for detected neighbour cells, a second neighbour cell threshold indicative of a threshold for an average number of neighbour cells over a given time period, a first primary cell threshold indicative of a threshold for signal strength of primary cell, a second primary cell threshold indicative of a threshold for signal quality of primary cell, and a third primary cell threshold indicative of a threshold for number of primary cell changes performed in a time period.
Item 8. Method according to any of items 1-7, the method comprising
   obtaining (S106) one or more UL parameters indicative of uplink-based mobility measurements performed in one or more network nodes, wherein obtaining (S106) one or more UL parameters comprises performing (S106A) uplink-based mobility measurements for provision of one or more UL parameters indicative of uplink-based mobility measurements in accordance with the one or more configuration messages.
Item 9. Method according to any of items 1-8, wherein generating (S102) one or more configuration messages comprises generating (S102B) a second configuration message, the second configuration message comprising one or more second configuration parameters indicative of a reference signal configuration, the method comprising transmitting (S108) the second configuration message to the wireless device.
Item 10. Method according to item 9, wherein the one or more second configuration parameters are indicative of a Non-Orthogonal Multiple Access, NOMA, configuration.
Item 11. Method according to any of items 9-10 as dependent on item 8, wherein performing (S106A) uplink-based mobility measurements is performed in accordance with the one or more second configuration parameters.
Item 12. Method according to any of items 1-11, wherein generating (S102) one or more configuration messages comprises generating (S102C) a third configuration message, the third configuration message comprising one or more third configuration parameters indicative of physical resources to be used by the wireless device for transmitting reference signals, the method comprising transmitting (S110) the third configuration message to the wireless device.
Item 13. Method according to item 12 as dependent on item 8, wherein performing (S106A) uplink-based mobility measurements is performed in accordance with the one or more third configuration parameters.
Item 14. Method according to any of items 1-13, wherein generating (S102) one or more configuration messages comprises generating (S102D) a fourth configuration message indicative of deactivation of uplink-based mobility measurements, the method comprising transmitting (S120) the fourth configuration message to the wireless device.
Item 15. A method (200), performed at a wireless device, for uplink-based mobility management, the method comprising:
   receiving (S202), from a network node, one or more configuration messages indicative of an uplink-based mobility scheme; and
   applying (S204) an uplink-based mobility scheme in the wireless device according to the one or more configuration messages.
Item 16. Method according to item 15, wherein receiving (S202), from a network node, one or more configuration messages indicative of an uplink-based mobility scheme comprises receiving (S202A) a first configuration message, the first configuration message comprising one or more first configuration parameters comprising an uplink criteria configuration indicative of uplink criteria to be satisfied for a wireless device to apply an uplink-based mobility scheme, and wherein applying (S204) uplink-based mobility scheme in the wireless device according to the one or more configuration messages comprises:
   determining (S206) if uplink criteria are satisfied; and
   in accordance with uplink criteria being satisfied, transmitting (S208) a reference signal to one or more network nodes.
Item 17. Method according to any of items 15-16, wherein receiving (S202), from the network node, one or more configuration messages comprises receiving (S202B) a second configuration message, the second configuration message comprising one or more second configuration parameters indicative of a reference signal configuration, and wherein applying (S204) uplink-based mobility scheme in the wireless device according to the one or more configuration messages comprises generating (S210) a reference signal based on at least one of the one or more second configuration parameters, and transmitting the reference signal to one or more network nodes.
Item 18. Method according to item 17, wherein the one or more second configuration parameters are indicative of a Non-Orthogonal Multiple Access, NOMA, configuration, and wherein the reference signal is based on the Non-Orthogonal Multiple Access configuration.
Item 19. Method according to any of items 17-18, wherein the one or more second configuration parameters are indicative of one or both of an antenna configuration and a transmission power level configuration, and wherein the reference signal is based on the antenna configuration and/or the transmission power level configuration.
Item 20. Method according to any of items 15-19, wherein receiving (S202), from the network node, one or more configuration messages comprises receiving (S202C) a third configuration message, the third configuration message comprising one or more third configuration parameters indicative of physical resources to be used by the wireless device for transmitting reference signals, and wherein applying (S204) uplink-based mobility scheme in the wireless device according to the one or more configuration messages comprises generating (S212) a reference signal based on at least one of the one or more third configuration parameters, and transmitting the reference signal to one or more network nodes.
Item 21. Method according to any of items 15-20, wherein receiving (S202), from the network node, one or more configuration messages comprises receiving (S202D) a fourth configuration message indicative of deactivation of uplink-based mobility scheme, and wherein applying (S204) uplink-based mobility scheme in the wireless device according to the one or more configuration messages comprises, in response to receiving the fourth configuration message, deactivating the uplink-based mobility scheme.
Item 22. Method according to any of items 15-21, the method comprising:

determining (S214) if a downlink criterion is satisfied; and in accordance with the downlink criterion being satisfied, applying (S216) a downlink-based mobility scheme in the wireless device.
Item 23. A network node (300) of a wireless communications network, the network node (300) comprising a memory module (301), a processor module (302), and a wireless interface (303), wherein the network node (300) is configured to perform a method according to any of items 1-14.
Item 24. A wireless device (400) comprising a memory module (401), a processor module (402), and a wireless interface (403), wherein the wireless device (400) is configured to perform a method according to any of items 15-22.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1-7 comprises some modules or operations which are illustrated with a solid line and some modules or operations which are illustrated with a dashed line. The modules or operations which are comprised in a solid line are modules or operations which are comprised in the broadest example embodiment. The modules or operations which are comprised in a dashed line are example embodiments which may be comprised in, or a part of, or are further modules or operations which may be taken in addition to the modules or operations of the solid line example embodiments. It should be appreciated that these operations need not be performed in order presented. Furthermore, it should be appreciated that not all of the operations need to be performed. The exemplary operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the exemplary embodiments may be implemented at least in part by means of both hardware and software, and that several “means”, “units” or “devices” may be represented by the same item of hardware.

The various exemplary methods, devices, nodes and systems described herein are described in the general context of method steps processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform specified tasks or implement specific abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed invention, and it will be made obvious to those skilled in the art that various changes and modifications may be made without departing from the spirit and scope of the claimed invention. The specification and drawings are, accordingly to be regarded in an illustrative rather than restrictive sense. The claimed invention is intended to cover all alternatives, modifications, and equivalents.

1. A method, performed at a first network node, for uplink-based mobility management, the method comprising:
generating one or more configuration messages including generating a first configuration message for configuration of uplink-based mobility, the first configuration message comprising one or more first configuration parameters indicative of an uplink-based mobility scheme for a wireless device; and
transmitting the first configuration message to the wireless device.

2. The method according to claim 1, wherein the one or more first configuration parameters are indicative of a request to apply uplink-based mobility scheme in the wireless device.

3. The method according to claim 1, wherein the one or more first configuration parameters comprise an uplink criteria configuration indicative of uplink criteria to be satisfied for a wireless device to apply an uplink-based mobility scheme.

4. The method according to claim 3, wherein the uplink criteria configuration comprises one or more of a first neighbour cell threshold indicative of a threshold for number of detected neighbour cells, a second neighbour cell threshold indicative of a threshold for an average number of neighbour cells detected over a given time period, a first primary cell threshold indicative of a threshold for signal strength of primary cell, a second primary cell threshold indicative of a threshold for signal quality of primary cell, and a third primary cell threshold indicative of a threshold for number of primary cell changes performed in a time period.

5. The method according to claim 1, wherein the one or more first configuration parameters comprise a downlink criteria configuration indicative of downlink criteria to be satisfied for a wireless device to stop applying the uplink based mobility scheme and to start applying a downlink based mobility scheme in the wireless device, and
wherein the uplink criteria to be satisfied are different from the downlink criteria to be satisfied

6. (canceled)

7. The method according to claim 1, wherein the downlink criteria configuration comprises one or more of a first neighbour cell threshold indicative of a threshold for detected neighbour cells, a second neighbour cell threshold indicative of a threshold for an average number of neighbour cells over a given time period, a first primary cell threshold indicative of a threshold for signal strength of primary cell, a second primary cell threshold indicative of a threshold for signal quality of primary cell, and a third primary cell threshold indicative of a threshold for number of primary cell changes performed in a time period.

8. The method according to claim 1, the method comprising:
obtaining one or more UL parameters indicative of uplink-based mobility measurements performed in one or more network nodes, wherein obtaining one or more UL parameters comprises performing uplink-based mobility measurements for provision of one or more UL parameters indicative of uplink-based mobility measurements in accordance with the one or more configuration messages.

9. The method according to claim 1, wherein generating one or more configuration messages comprises generating a second configuration message, the second configuration message comprising one or more second configuration parameters indicative of a reference signal configuration for a reference signal to be transmitted from the wireless device, the method comprising transmitting the second configuration message to the wireless device, and
wherein the one or more second configuration parameters are indicative of a Non-Orthogonal Multiple Access, NOMA, configuration.

10. (canceled)

11. The method according to claim 1, wherein generating one or more configuration messages comprises generating a second configuration message, the second configuration message comprising one or more second configuration parameters indicative of a reference signal configuration for a reference signal to be transmitted from the wireless device, the method comprising transmitting the second configuration message to the wireless device, and wherein performing uplink-based mobility measurements is performed in accordance with the one or more second configuration parameters

12. The method according to claim 1, wherein generating one or more configuration messages comprises generating a third configuration message, the third configuration message comprising one or more third configuration parameters indicative of physical resources to be used by the wireless device for transmitting reference signals, the method comprising transmitting the third configuration message to the wireless device, and wherein generating one or more configuration messages comprises generating a fourth configuration message indicative of deactivation of uplink-based mobility measurements, the method comprising transmitting the fourth configuration message to the wireless device.

13. The method according to claim 1, wherein generating one or more configuration messages comprises generating a third configuration message, the third configuration message comprising one or more third configuration parameters indicative of physical resources to be used by the wireless device for transmitting reference signals, the method comprising transmitting the third configuration message to the wireless device, and wherein performing uplink-based mobility measurements is performed in accordance with the one or more third configuration parameters.

14. (canceled)

15. A method, performed at a wireless device, for uplink-based mobility management, the method comprising:
receiving, from a network node, one or more configuration messages indicative of an uplink-based mobility scheme; and
applying an uplink-based mobility scheme in the wireless device according to the one or more configuration messages.

16. The method according to claim 15, wherein receiving, from a network node, one or more configuration messages indicative of an uplink-based mobility scheme comprises receiving a first configuration message, the first configuration message comprising one or more first configuration parameters comprising an uplink criteria configuration indicative of uplink criteria to be satisfied for a wireless device to apply an uplink-based mobility scheme, and wherein applying uplink-based mobility scheme in the wireless device according to the one or more configuration messages comprises:
determining if uplink criteria are satisfied; and
in accordance with uplink criteria being satisfied, transmitting a reference signal to one or more network nodes.

17. The method according to claim 15, wherein receiving, from the network node, one or more configuration messages comprises receiving a second configuration message, the second configuration message comprising one or more second configuration parameters indicative of a reference signal configuration, and wherein applying uplink-based mobility scheme in the wireless device according to the one or more configuration messages comprises generating a reference signal based on at least one of the one or more second configuration parameters, and transmitting the reference signal to one or more network nodes, and wherein the one or more second configuration parameters are indicative of a Non-Orthogonal Multiple Access, NOMA, configuration, and wherein the reference signal is based on the Non-Orthogonal Multiple Access configuration.

18. (canceled)

19. The method according to claim 15, wherein the one or more second configuration parameters are indicative of one or both of an antenna configuration and a transmission power level configuration, and wherein the reference signal is based on the antenna configuration and/or the transmission power level configuration.

20. The method according to claim 15, wherein receiving, from the network node, one or more configuration messages comprises receiving a third configuration message, the third configuration message comprising one or more third configuration parameters indicative of physical resources to be used by the wireless device for transmitting reference signals, and wherein applying uplink-based mobility scheme in the wireless device according to the one or more configuration messages comprises generating a reference signal based on at least one of the one or more third configuration parameters, and transmitting the reference signal to one or more network nodes.

21. The method according to claim 15, wherein receiving, from the network node, one or more configuration messages comprises receiving a fourth configuration message indicative of deactivation of uplink-based mobility scheme, and wherein applying uplink-based mobility scheme in the wireless device according to the one or more configuration messages comprises, in response to receiving the fourth configuration message, deactivating the uplink-based mobility scheme.

22. The method according to claim 15, the method comprising:
determining if a downlink criterion is satisfied; and
in accordance with the downlink criterion being satisfied, applying a downlink-based mobility scheme in the wireless device.

23. A network node of a wireless communications network, the network node comprising a memory module, a processor module, and a wireless interface, wherein the network node is configured to perform a method according to claim 1.

24. A wireless device comprising a memory module a processor module, and a wireless interface, wherein the wireless device is configured to perform a method according to claim 15.
